(19) United States
(12) Patent Application Publication
(10) Pub. No.: US 2026/0021677 A1
(43) Pub. Date: Jan. 22, 2026

(54) BICYCLE REAR WHEEL

(71) Applicant: Mariusz KOZAK, Swidnik (PL)

(72) Inventor: Mariusz KOZAK, Swidnik (PL)

(21) Appl. No.: 18/995,098

(22) PCT Filed: Jul. 5, 2023
(86) PCT No.: PCT/IB2023/056965

§ 371 Date: Jan. 15, 2025

(30) Foreign Application Priority Data
Jul. 15, 2022 (PL) PL P.441745

(51) Int. Cl. B60B 27/02; B60B 1/00; B60B 27/00; F16D 41/32

(52) U.S. Cl. CPC B60B 27/023; B60B 1/003; B60B 27/0026; F16D 41/32

(57) ABSTRACT

The present disclosure includes a rear wheel of a bicycle including a tire rim with spokes, a hub axle on which at least one chain drive wheel is rotatably mounted, and a one-way clutch assembly. The one-way clutch assembly includes a flange and a disc placed next to each other, seated coaxially and with a gap. The flange is ball-bearing mounted on the hub axle, and the disc is integrated with the chain drive wheel. In some instances, these elements have side surfaces facing each other and one of the elements: the flange or the disc, has teeth on its side surface, and the other element has on its side surface at least one hook located at a distance from the axis of the hub similar to or the same as the position of the tooth.

### TECHNICAL FIELD

The subject of the invention is a bicycle rear wheel with spokes.

### BACKGROUND ART

The bicycle rear wheel is typically made of a hub to which a rim with a tire is attached through spokes. The hub consists of a hub axle on which a rotatable hub body is ball-bearing mounted. The body of the hub has flanges for fixing the spokes. On one of the ends of the hub axle, a rotatable clutch body is ball-bearing mounted, with splines for mounting a bicycle cassette consisting of sprockets. The hub also includes a one-way clutch, which is most commonly a roller, ratchet or disc clutch.

The ratchet clutch is made of a rim and pawls. The rim is usually a metal serrated ring with internal teeth, while pawls usually have springs, thanks to which the pawl is pressed against the tooth of the ring, effecting engagement. In this case, the rim is attached to the hub body, and the pawls to the clutch body. The reverse arrangement is also possible, where the rim is made with external teeth and is attached to the clutch body, and the pawls are in the hub body. One pawl is sufficient for coupling, but the number of engagement points affects the ride, so the aim is to increase the number of engagements. In this solution, the greater the transmitted torque, the greater the force pressing the clutch elements together.

Another type of a bicycle clutch is the disc clutch, made up of two interlocking discs. Both discs have lateral play in relation to their shafts and at the same time are axially coupled with these shafts. Coupling occurs due to the pressure of the discs against each other, which can be achieved e.g. by springs. Such a clutch has a greater ability to transmit torque. The force with which the clutch discs are pressed together depends on the angle of inclination of the tooth and the twisting torque. The pressure can also be achieved by using neodymium magnets.

A rear bicycle wheel hub assembly is known from the publication of the patent description U.S. Pat. No. 10,752,320B2, comprising: a hub axle including a through hole of the axle with a minimum internal diameter equal to or greater than 13 mm; a hub body rotatably mounted on the hub axle around a central axis of rotation; and a gear wheel clutch body rotatably mounted on the hub axle, the clutch body including at least one external splined tooth for engaging the rear gear wheel assembly of the bicycle. This tooth contains a spline that receives the torque generated during pedalling. The splined outer drive surfaces include a radially helical edge that cooperates with the toothed discs. The radially helical edges allow one toothed disc to move relative to the other. The solution is characterized by a small number of interlocking points and a rather complicated structure.

From the publication of the utility model DE202021106715U1 a bicycle hub is known comprising: a central axis serving as the axis of rotation of the bicycle hub; the main body rotatably connected to the central axis; a freewheel pivotally connected to the central axis and designed to get connected to a set of sprockets, the freewheel having multiple splined teeth. The hub comprises a clutch assembly comprising two ratchet discs having teeth and splines respectively for sliding engagement along the longitudinal direction. One of the ratchet discs is connected to the main body so that it can drive the main body to rotate, and the other disc is connected to the one-way clutch so that it can drive the one-way clutch. The clutch assembly includes an adjusting element connected to the second ratchet disc and exerts a force to displace the second ratchet disc, thereby returning the second ratchet disc to its original position. The adjusting element is a spring, a magnet or is made of an clastic material.

The publication of the application CN114055996A discloses the construction of a one-way gear hub and a bicycle. The mechanism includes a hub assembly and a ratchet wheel assembly. The ratchet wheel assembly is mounted by a first engagement mechanism, the ratchet wheel assembly is coupled with the hub assembly by means of a second engagement mechanism. The ratchet wheel assembly is a one-way support structure and includes a ratchet wheel seat and a ratchet wheel sleeve. In the socket of the ratchet wheel there are rolling elements and springs supporting the respective rolling elements. The ratchet wheel sleeve covers the ratchet wheel socket and all springs and rolling elements in the ratchet wheel socket. The springs press the respective rolling element into contact with the ratchet wheel seat and the ratchet wheel sleeve. The structure has a large mass. In addition, there are high radial forces in the structure. As a result, the solution may have a low durability.

Patent publication U.S. Pat. No. 10,723,174B2 relates to a bicycle freewheel which has two annular bodies. The first annular ferromagnetic body rotates with the bicycle sprockets and includes a first crowned ring gear. The second annular body rotates with the rear wheel of the bicycle and has a second crowned ring gear matching the first crowned ring gear and facing in its direction. The first annular body is axially movable relative to the second annular body between an engagement condition in which the first ring gear is coupled with the second ring gear and a disengagement condition in which they arc decoupled. At least one magnetic body is arranged radially outward from the first annular body so that the first annular body in the disengagement condition is at least partially contained within the axial space of the magnetic body.

### Technical Problem

The aim of the invention is to propose a construction of the rear wheel of a bicycle to feature simple construction and quiet operation in the condition in which the elements forming the one-way clutch are not coupled. The simplicity of the design will give the reduction in the number of structural elements, as a result of which the wheel will be lighter, easier to manufacture, more ecological, and its service also will be easier.

### SUMMARY OF INVENTION

The essence of the rear wheel of a bicycle comprising a tire rim with spokes, a hub axle on which at least one chain drive wheel is rotatably mounted, and a one-way clutch assembly, is based on the fact that the one-way clutch assembly consists of: a flange and a disc arranged next to each other, set coaxially and with a slot, where the flange is ball-bearing mounted on the hub axis, and the disc is integrated with the chain drive wheel. These elements have side surfaces facing each other, and one of the elements, the flange or the disc, has teeth on its side surface, and the other element has at least one hook on its side surface, corresponding to the position of the tooth.

Preferably, the second of the elements: the flange or the disc, has on its side surface a plurality of hooks corresponding to the location of the teeth.

Preferably, the teeth and the hook are arranged in a circle, the radius of the circle along which at least one hook is located is in the range: r=R-0.5g-10 mm=R+0.5g+10 mm, where: R-radius of the circle along which the teeth are arranged, g-width of the tooth.

Preferably, the radii of the circles along which the teeth and the hook are arranged are the same.

Preferably, the flange is a part of the hub body.

Preferably, the spokes are attached to the flange.

Preferably, the hooks are arranged symmetrically with respect to the axis of the hub.

Preferably, the hooks are loops.

Preferably, the hooks are fixed rigidly with an initial pressing bend for catching the tooth.

Preferably, there are at least two hooks for engaging one tooth.

Preferably, the hooks have different lengths, and the difference in the length of the extreme hooks is less than the distance between the successive tips of the teeth.

Preferably, the tooth on the side opposite to the direction of rotation of the element on which it is located has a concave side surface and/or the tip of the tooth is shifted towards the bottom of the notch located on the side of the tooth opposite to the direction of rotation of the element on which it is located, and from the side coinciding with the direction of rotation of the element it has a convex side surface.

Preferably, the tooth has a width of not more than 30 mm.

Preferably, the diameter of the circle on which the teeth and the hook are arranged is not less than 60 mm and not greater than 55% of the diameter of the wheel rim.

### Advantageous Effects of Invention

Thus, the solution according to the present invention is meant to simplify the structure of the hub and the rear wheel of the bicycle. The use of the flange and the disc, of which one element has teeth and the other a hook or hooks, allows to reduce the number of structural elements, for example, the solution allows to use a hub body with a simplified structure. A smaller number of elements has an impact on reducing the failure rate. Wheel servicing is made easier. The use of the flange and disc of the indicated design eliminates knocking, which occurs with traditional and known solutions, in the case of the mechanism being decoupled. Precisely, the hooks, and especially the hooks made as loops “jumping over” the teeth in the disengagement condition, are much quieter than e.g. pawls in a ratchet or disc clutch. In addition, the solution envisages that the diameter of the circle on the flange and the disc, along which the teeth and the hook are arranged, will not be less than 60 mm and not greater than 55% of the wheel rim. The use of a flange and a disc of such dimensions allows for multiple attachment points, which increases the precision of coupling. Many attachment points also increase the reliability and safety of the mechanism-damage to one of the attachment points will not cause the wheel to fail. In addition, contrary to the known solutions, operation of the hooks is based on tension, not compression. Another advantage is that due to the larger than the known dimensions of the clutch elements, the driving force acting on the teeth and hooks is smaller, which further improves the safety of the structure. Application of plurality of hooks of different lengths, where the difference in the length of the extreme hooks is smaller than the distance between the tips of the teeth, allows to increase the number of catching points, with the constant number of teeth. This ensures an increase in clutch sensitivity, e.g. with a smaller number of hook attachment points.

### BRIEF DESCRIPTION OF DRAWINGS

The subject of the invention is presented in exemplary embodiments in the drawing, where:

FIG. 1 schematically shows the rear wheel of a bicycle;

FIG. 2 schematically shows a cross-section of the wheel in the variant with teeth on the flange;

FIG. 3 schematically shows a side view of the flange surface with teeth arranged along a circle;

FIG. 4 schematically shows a side view of the disc surface with hooks arranged along a circle;

FIG. 5 shows schematically an enlarged view of the tooth structure, looking in the direction of the arrow “A” indicated in FIG. 3 and FIG. 8;

FIG. 6 schematically shows a cross-section of the wheel in the variant with teeth on the disc;

FIG. 7 schematically shows a side view of the flange surface with hooks arranged along a circle;

FIG. 8 schematically shows a side view of the disc surface with teeth arranged along a circle;

FIG. 9 schematically shows a side view of the variant with a plurality of hooks for catching one tooth;

FIG. 10 schematically shows a way of catching one tooth by the multiple hook;

FIG. 11 schematically shows a side view of one of the elements' surface: a flange or a disc with teeth arranged in other way than along a circle;

FIG. 12 schematically shows a side view of the other element's surface: a flange or a disc with hooks arranged in other way than along a circle;

FIG. 13 schematically shows a cross-section B-B, as indicated in FIG. 11, of a flange or a disc with teeth arranged in other way than along a circle.

### DESCRIPTION OF EMBODIMENTS

### Example 1

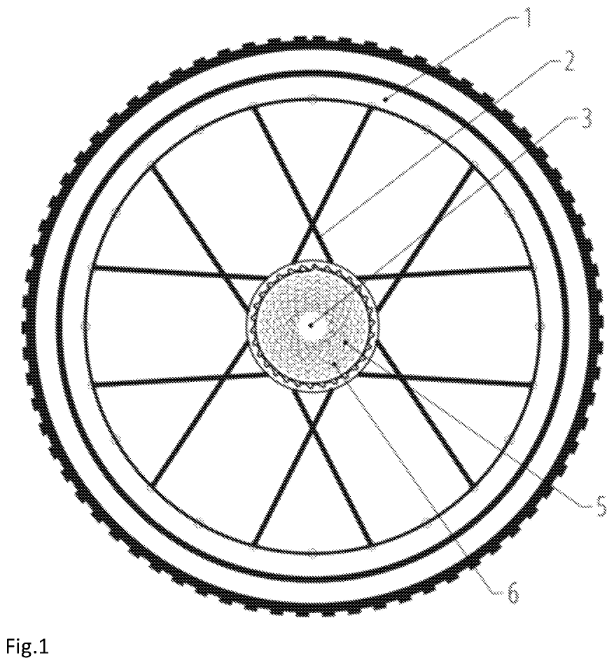

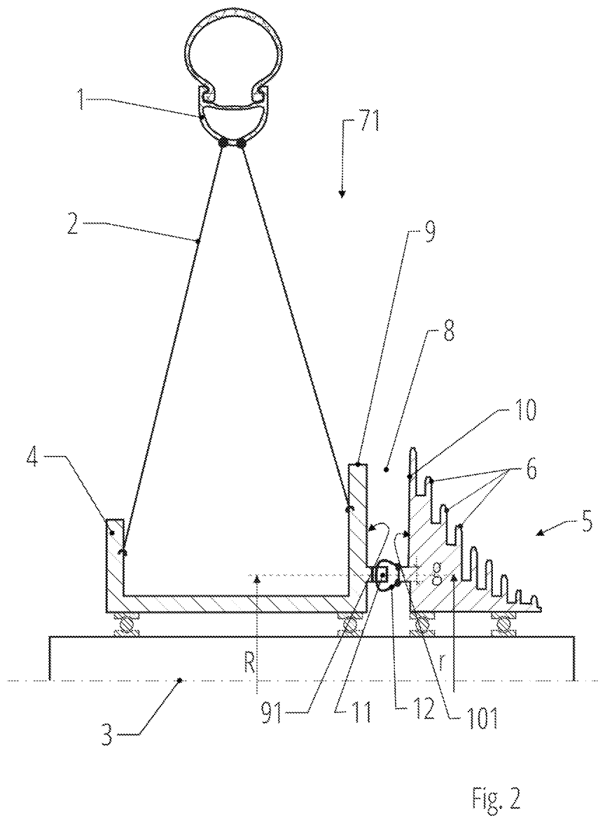

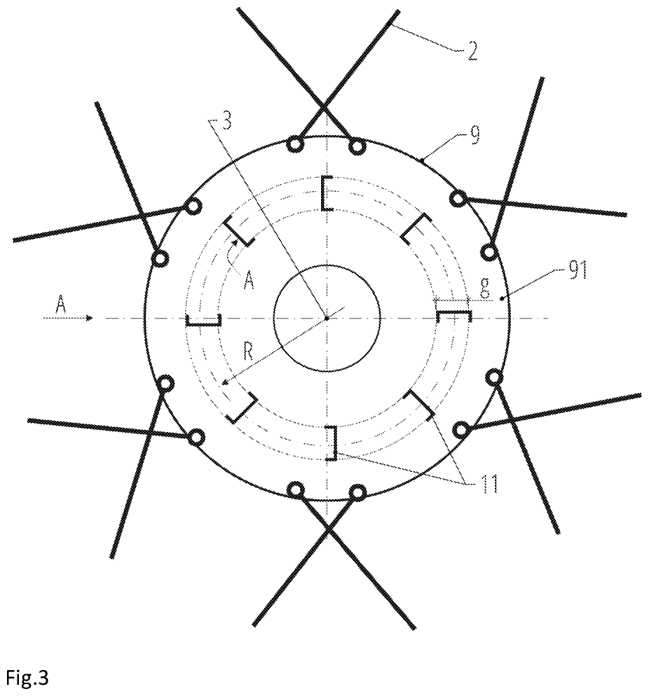

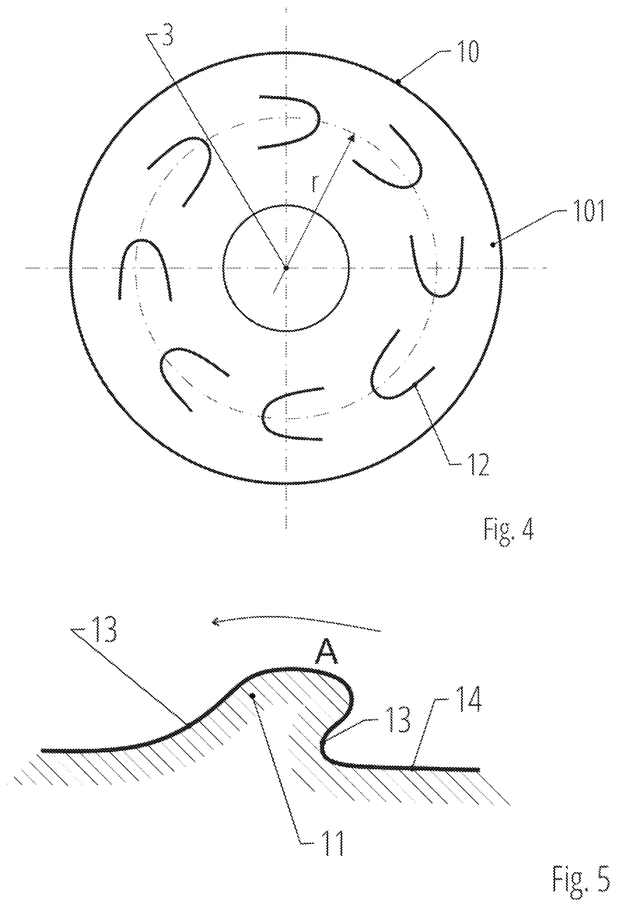

The rear wheel of the bicycle is constructed, as shown in FIG. 1, of the tire rim 1 with spokes 2, the axle 3 of the hub. On the axle 3 of the hub, the following parts are rotatably ball-bearing mounted: the body 4 of the hub and the cassette 5 with the chain drive wheels 6. The wheel includes the one-way clutch assembly 71, shown in FIG. 2-FIG. 4, which consists of arranged side-by-side, coaxially seated with the gap 8 between them: the flange 9 and the disc 10. The flange 9 is ball-bearing mounted on the axle 3 of the hub, and the disc 10 is integrated with the largest chain drive wheel 6. The elements 9 and 10 have respective side surfaces 91 and 101 facing each other. In this exemplary embodiment, the flange 9 has the teeth 11 on its side surface 91, while the disc 10 has a plurality of hooks 12 on its side surface 101. The hooks 12 are in the form of loops. The teeth 11 and the hooks 12 are arranged along a circle with the same radius, R=r. The flange 9 is part of the hub body 4. The spokes 2 are fixed to the flange 4. The hooks 12 are arranged symmetrically with respect to the axis 3 of the hub. The hooks 12 in the form of loops are fixed rigidly with an initial pressing bend, in order to catch the tooth 11. The tooth 11, as shown in FIG. 5 has a concave side surface 13 on the side opposite to the direction of rotation of the flange 9 and the tip A of the tooth 11 is shifted towards the bottom of the notch 14 located on the side of the tooth 11 opposite to the direction of rotation of the flange 9. On the side coincident with the direction of rotation of the flange 9, the tooth 11 has a convex side surface 13. The tooth 11 has a width g=9 mm. The diameter of the circle on which: the teeth 11 and the hook 12 are arranged, is in the range of 60 mm=55% of the diameter of the wheel im.

### Example 2

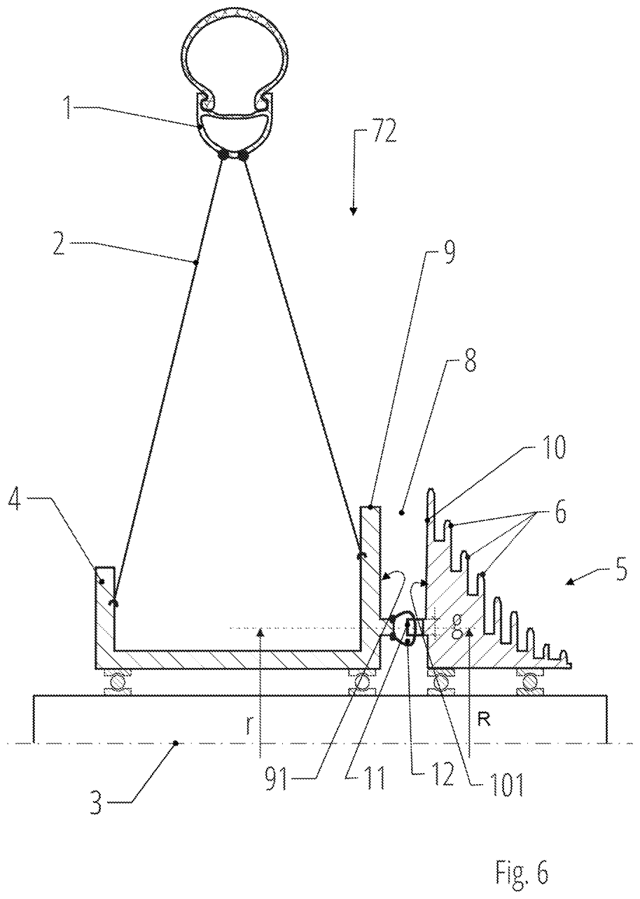

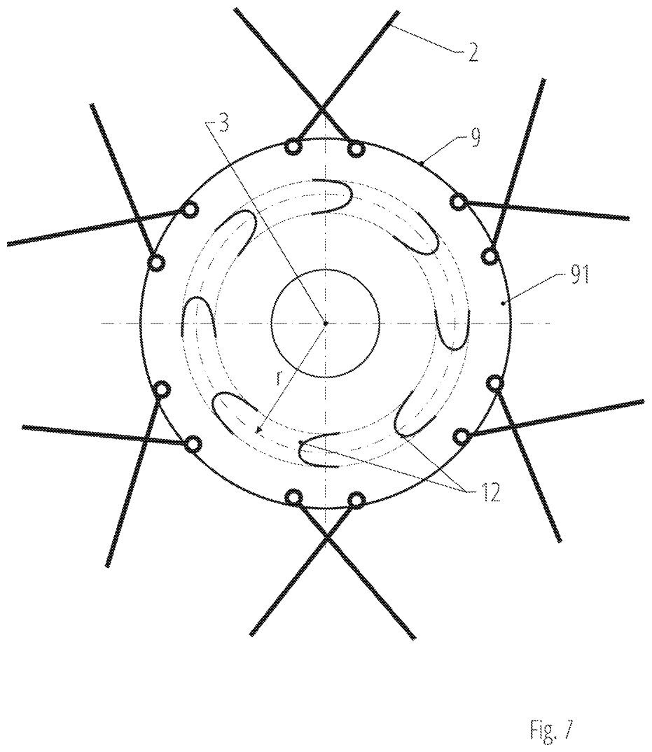

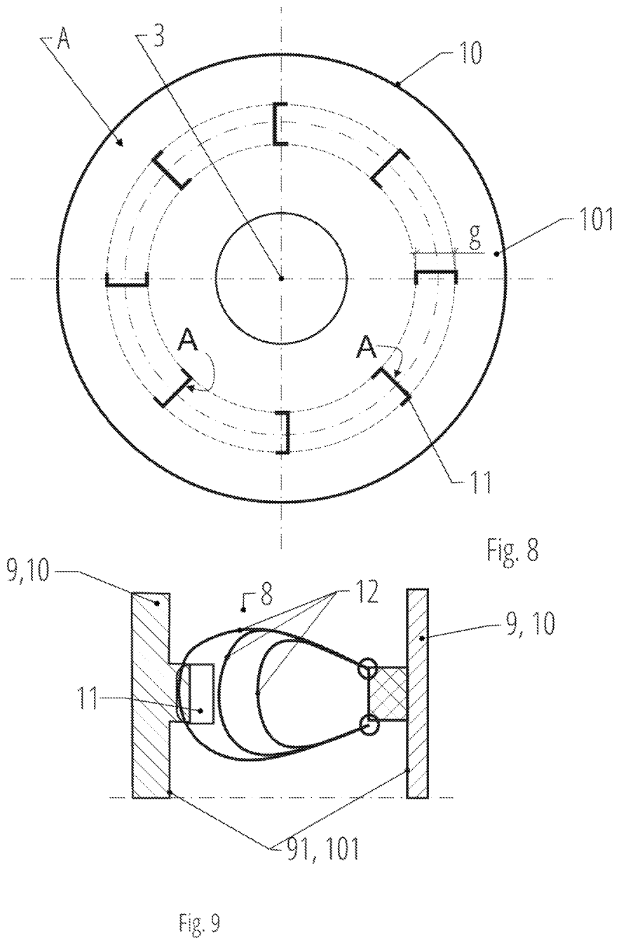

The wheel is made as in example 1 except that in the one-way clutch assembly 72 shown in FIG. 6-FIG. 8, the flange 9 has a plurality of hooks 12 on its side surface 91, and the disc 10 has teeth 11 on its side surface 101. The tooth 11 on the side opposite to the direction of rotation of the disc 10 has a concave side surface 13 and the tip A of the tooth 11 is shifted towards the bottom of the notch 14 located on the side of the tooth 11 opposite to the direction of rotation of the disc 10. On the side coincident with the direction of rotation of the disc 10, the tooth 11 has a convex side surface 13.

### Example 3

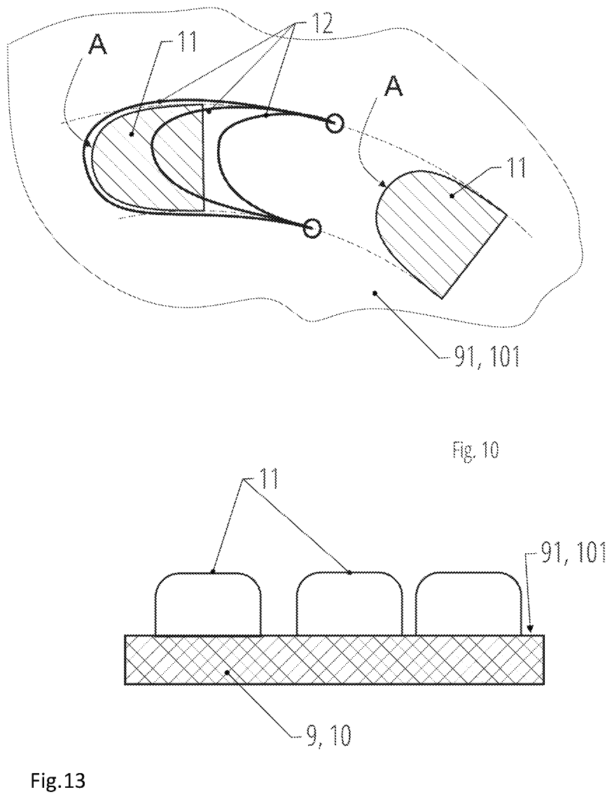

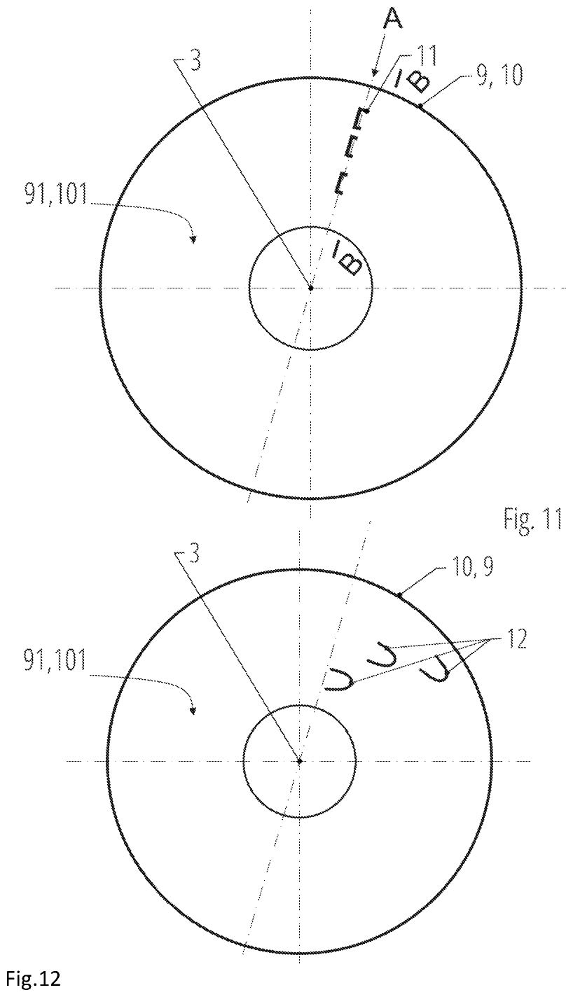

The wheel is made as in example 1 or 2, except that on the side surface 91 or 101 of the flange 9 or the disc 10, respectively, there are three hooks 12 for catching one tooth 11. The hooks 12 have different lengths, and the difference in the length of the extreme hooks 11 is less than the distance between successive tips A of the teeth 11-FIG. 9, FIG. 10.

### Example 4

The wheel is made as in example 1 or 2, except that on the side surface 91 or 101 of the flange 9 or the disc 10, respectively, there are teeth 11, and on the side surface 91 or 101 of the second element of the clutch assembly 71, 72, there are hooks 12. The teeth 11 are located at different distances from the axis 3 of the hub. At the same distances from the axis 3 of the hub as the location of each of the teeth 11, the hooks 12 are located-FIG. 11, FIG. 12. The hooks 12 are arranged with an angular shift, so that in a given position of the elements: the flange 9 and the disc 10 rotating relative to each other, catching of another tooth 11 by the hook 12 is possible.

List of elements:

| | |
|---|---|
| 1 | rim |
| 2 | spokes |
| 3 | hub axle |
| 4 | hub body |
| 5 | cassette |
| 6 | drive chain wheel |
| 71 | one-way clutch assembly variant 1 |
| 72 | one-way clutch assembly variant 2 |
| 8 | gap |
| 9 | flange |
| 91 | side surface of the flange |
| 10 | disc |
| 101 | side surface of the disc |
| 11 | tooth |
| 12 | hook |
| 13 | lateral surface of the tooth |
| 14 | bottom of the notch |
| A | tip of the tooth |
| g | width of the tooth |
| R | the radius of the circle on which the teeth are located |
| r | the radius of the circle on which the hook is located |

1. A bicycle rear wheel comprising a tire rim with spokes, a hub axle on which at least one chain drive wheel is rotatably mounted, and a one-way clutch assembly, wherein the one-way clutch assembly includes a flange and a disc located next to each other, arranged coaxially and with a gap, the flange being ball bearing mounted on the axle of the hub, and the disc is integrated with the chain drive wheel and these elements have side surfaces facing each other and one of the elements: the flange or the disc, has on its side surface teeth, and the other element has on its side surface at least one hook situated at a distance from the axis of the hub similar to or the same as the position of the tooth.

2. The rear wheel of a bicycle according to claim 1, wherein the other of the elements: the flange or the disc, has on its side surface a plurality of hooks whose location corresponds to the position of the teeth.

3. The rear wheel of a bicycle according to claim 1, wherein the teeth and the hook are arranged along a circle, wherein the radius of the circle on which at least one hook is arranged is in the range: r=R−0.5g−10 mm+R+0.5g+10 mm, where: R-radius of the circle along which the teeth are arranged, g—width of the tooth.

4. The rear wheel according to claim 3, wherein the radii of the circles, along which the teeth and the hook are located, are the same.

5. The rear wheel according to claim 1, wherein the flange is a part of the hub body.

6. The rear wheel according to claim 1, wherein the spokes are fixed to the flange.

7. The rear wheel of a bicycle according to claim 1, wherein the hooks are arranged symmetrically in relation to the hub axis.

8. The rear wheel of a bicycle according to claim 1, wherein the hooks are loops.

9. The rear wheel of a bicycle according to claim 8, wherein the hooks are attached rigidly with an initial pressing bend, in order to catch the tooth.

10. The rear wheel of a bicycle according to claim 1, wherein there are at least two hooks to catch one tooth.

11. The rear wheel of a bicycle according to claim 10, wherein the hooks have different lengths and the difference in the length of the extreme hooks is smaller than the distance between successive tips of the teeth.

12. The rear wheel of a bicycle according to claim 1, wherein, characterized in that the tooth on the side opposite to the direction of rotation of the element on which it is located, has a concave side surface and/or the tip of the tooth is shifted towards the bottom of the notch located on the side of the tooth opposite to the direction of rotation of the element on which it is located, and on the side coincident with the direction of rotation of the element it has a convex side surface.

13. The rear wheel of a bicycle according to claim 1, wherein the tooth has a width of not more than 30 mm.

14. The rear wheel of a bicycle according to claim 1, wherein the diameter of the circle along which the teeth and the hook are arranged is not less than 60 mm and not more than 55% of the wheel rim diameter.

15. The rear wheel of a bicycle according to claim 2, wherein the other of the elements: the flange or the disc, has on its side surface a plurality of hooks whose location corresponds to the position of the teeth.

16. The rear wheel of a bicycle according to claim 2, wherein the teeth and the hook are arranged along a circle, wherein the radius of the circle on which at least one hook is arranged is in the range: r=R−0.5g mm=R+0.5g+10 mm, where: R-radius of the circle along which the teeth are arranged, g-width of the tooth.

17. The rear wheel according to claim 2, wherein the flange is a part of the hub body.

18. The rear wheel of a bicycle according to claim 2, wherein the diameter of the circle along which the teeth and the hook are arranged is not less than 60 mm and not more than 55% of the wheel rim diameter.

19. The rear wheel of a bicycle according to claim 2, wherein the tooth on the side opposite to the direction of rotation of the element on which it is located, has a concave side surface and/or the tip of the tooth is shifted towards the bottom of the notch located on the side of the tooth opposite to the direction of rotation of the element on which it is located, and on the side coincident with the direction of rotation of the element it has a convex side surface.

20. The rear wheel of a bicycle according to claim 2, wherein the diameter of the circle along which the teeth and the hook are arranged is not less than 60 mm and not more than 55% of the wheel rim diameter.
